(19) United States
(12) Patent Application Publication
(10) Pub. No.: US 2017/0291587 A1
(43) Pub. Date: Oct. 12, 2017

(54) VEHICLE DRIVING DEVICE

(71) Applicant: TOYOTA JIDOSHA KABUSHIKI KAISHA, Toyota-shi (JP)

(72) Inventors: Tomoaki YANAGIDA, Susono-shi (JP); Yoshio ITO, Susono-shi (JP)

(73) Assignee: TOYOTA JIDOSHA KABUSHIKI KAISHA, Toyota-shi (JP)

(21) Appl. No.: 15/456,609

(22) Filed: Mar. 13, 2017

(30) Foreign Application Priority Data
Apr. 12, 2016 (JP) 2016-079808

(51) Int. Cl. B60T 13/57; F02B 63/06; B60T 17/02

(52) U.S. Cl. CPC B60T 13/57; B60T 17/02; F02B 63/06

(57) ABSTRACT

A vehicle driving device includes: an engine; a brake booster including a negative pressure chamber, the brake booster amplifying a brake pressure by a negative pressure determined corresponding to a pressure inside the negative pressure chamber; a power transmission clutch disposed between the engine and a driving wheel; and a negative pressure pump configured to drive by using at least one of a torque from the engine and a torque from the driving wheel, the negative pressure pump being configured to vary the negative pressure inside the negative pressure chamber. In the vehicle driving device included in a vehicle that performs freewheeling in a state where the power transmission clutch is released and the engine is stopped, the negative pressure pump includes a control chamber configured to reduce a capacity of the negative pressure pump as a magnitude of the negative pressure inside the negative pressure chamber increases.

### CROSS-REFERENCE TO RELATED APPLICATION(S)

The present application claims priority to and incorporates by reference the entire contents of Japanese Patent Application No. 2016-079808 filed in Japan on Apr. 12, 2016.

### BACKGROUND

### 1. Technical Field

The disclosure relates to a vehicle driving device.

### 2. Related Art

Conventionally, there is known a technique to cause a clutch means to be in a released state and an engine to stop to perform freewheeling of a vehicle. For example, JP-A-2011-231844 discloses a vehicle driving device including a motor-generator (MG) and a negative pressure pump to generate a negative pressure used for a brake as auxiliary machines that are configured to be driven by selectively using the engine and a driving wheel.

In the above-described related art, when a driver performs an operation to turn on a brake while a vehicle is freewheeling, it is necessary to ensure a negative pressure for the brake by operating a negative pressure pump, which is an auxiliary machine. In this case, while the vehicle is freewheeling, the negative pressure is ensured from a negative pressure pump that is configured to be driven by a driving wheel described in JP-A-2011-231844 or an electrically driven negative pressure pump. On the other hand, with a normal negative pressure pump, it has been difficult to improve fuel efficiency since the negative pressure pump continues to generate the negative pressure when ordinarily travelling in which an engine is in an operating state to keep generating an energy loss of the engine caused by the negative pressure generation.

The disclosure has been made in view of the above-described circumstances, and it is an object of the disclosure to provide a vehicle driving device that can restrain a negative pressure pump from generating a negative pressure when a vehicle is ordinarily travelling and can improve fuel efficiency of the vehicle by reducing an energy loss caused by the negative pressure pump consuming the energy of the engine.

### SUMMARY

It is an object of the disclosure to at least partially solve the problems in the conventional technology.

In some embodiments, a vehicle driving device includes: an engine; a brake booster including a negative pressure chamber, the brake booster amplifying a brake pressure by a negative pressure determined corresponding to a pressure inside the negative pressure chamber; a power transmission clutch disposed between the engine and a driving wheel; and a negative pressure pump configured to drive by using at least one of a torque from the engine and a torque from the driving wheel, the negative pressure pump being configured to vary the negative pressure inside the negative pressure chamber. In the vehicle driving device included in a vehicle that performs freewheeling in a state where the power transmission clutch is released and the engine is stopped, the negative pressure pump includes a control chamber configured to reduce a capacity of the negative pressure pump as a magnitude of the negative pressure inside the negative pressure chamber increases.

The above and other objects, features, advantages and technical and industrial significance of this disclosure will be better understood by reading the following detailed description of presently preferred embodiments of the disclosure, when considered in connection with the accompanying drawings.

### BRIEF DESCRIPTION OF THE DRAWINGS

FIG. 1 is a skeleton diagram illustrating a configuration of a vehicle including a vehicle driving device according to an embodiment of the disclosure;

FIG. 2 is a schematic diagram illustrating a configuration of a variable-displacement negative pressure pump according to the embodiment of the disclosure;

FIG. 3 is a schematic diagram illustrating the configuration of the variable-displacement negative pressure pump according to the embodiment of the disclosure;

FIG. 4 is a circuit diagram illustrating a first air pressure circuit according to a first example of the disclosure;

FIG. 5 is a graph illustrating a suction performance (a) of a negative pressure pump and a control pressure (b) of the variable-displacement negative pressure pump corresponding to a negative pressure of a brake booster in the first air pressure circuit according to the first example of the disclosure;

FIG. 6 is a circuit diagram illustrating a second air pressure circuit according to a second example of the disclosure;

FIG. 7 is a graph illustrating the suction performance (a) of the negative pressure pump and the control pressure (b) of the variable-displacement negative pressure pump corresponding to the negative pressure of the brake booster in the second air pressure circuit according to the second example of the disclosure;

FIG. 8 is a circuit diagram illustrating a third air pressure circuit according to a third example of the disclosure;

FIG. 9 is a graph illustrating the suction performance (a) of the negative pressure pump and the control pressure (b) of the variable-displacement negative pressure pump corresponding to the negative pressure of the brake booster in the third air pressure circuit according to the third example of the disclosure;

FIG. 10 is a schematic diagram illustrating a structure of the variable-displacement negative pressure pump according to a modification of the embodiment of the disclosure; and

FIG. 11 is a schematic diagram illustrating a structure of the variable-displacement negative pressure pump according to a modification of the embodiment of the disclosure.

### DETAILED DESCRIPTION OF THE PREFERRED EMBODIMENTS

The following describes an embodiment of the disclosure with reference to the drawings. In all the drawings of the following embodiment, an identical or a corresponding portion is attached with an identical reference numeral. The disclosure is not limited by the embodiment described below.

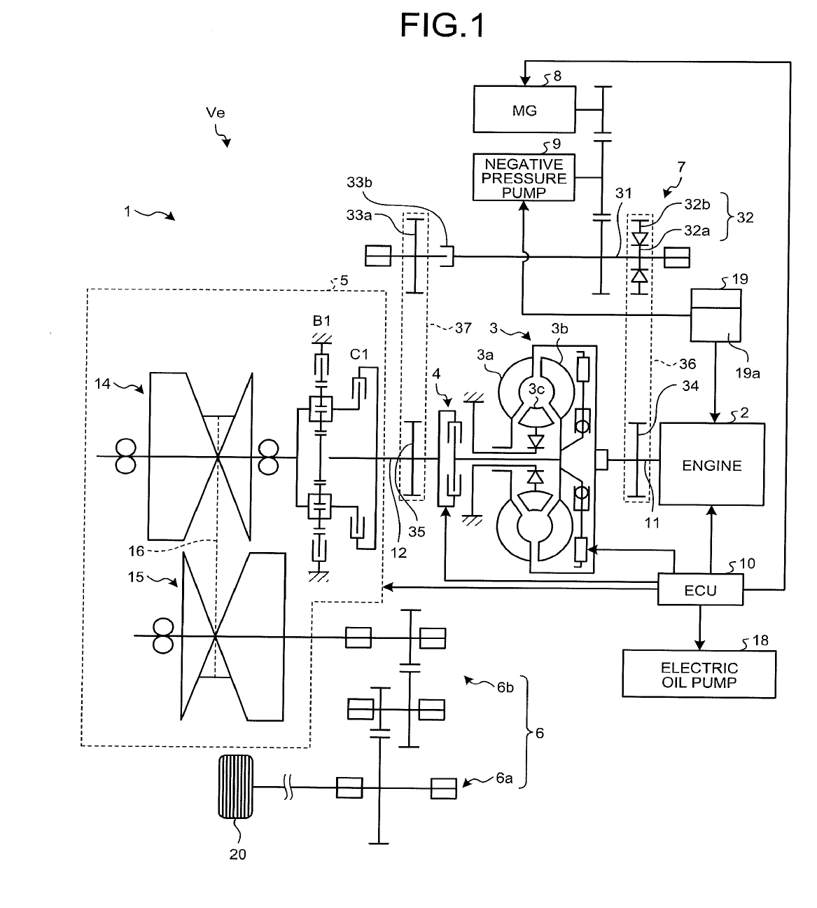

First, the following describes a configuration of a vehicle including a vehicle driving device according to the embodiment of the disclosure. FIG. 1 is a skeleton diagram illustrating the configuration of the vehicle including the vehicle driving device according to this embodiment.

As illustrated in FIG. 1, a vehicle driving device 1 in this embodiment is included in a vehicle Ve. The vehicle Ve includes an engine 2, a torque converter 3, an engine disengaging clutch 4, a shift transmission mechanism 5, a deceleration differential mechanism 6, a driving mechanism 7, a motor-generator (MG) 8, a variable-displacement negative pressure pump 9, an electronic control unit (ECU) 10, an electric oil pump (EOP) 18, and a brake booster 19.

Power output from the engine 2 is input to the shift transmission mechanism 5 via the torque converter 3 and the engine disengaging clutch 4. The power is transmitted from the shift transmission mechanism 5 to a driving wheel 20 via the deceleration differential mechanism 6. A power transmission path is constituted between the engine 2 and the driving wheel 20.

The engine 2 is a power source of the vehicle Ve. The engine 2 converts a combustion energy of a fuel into a rotational motion of a crankshaft (an output shaft) 11 to output the combustion energy. When the engine 2 is started, for example, the MG 8 cranks the engine 2.

The torque converter 3 is a fluid transmission device, which transmits the power output from the engine 2 via a hydraulic fluid (hydraulic oil). The torque converter 3 is disposed between the engine 2 and the engine disengaging clutch 4 on the power transmission path. The torque converter 3 includes pump impellers 3a, turbine runners 3b, and stators 3c. The pump impeller 3a is coupled to the crankshaft 11 of the engine 2. The turbine runner 3b is coupled to an input shaft 12 of the shift transmission mechanism 5. The input shaft 12 of the shift transmission mechanism 5 functions as an output shaft to transmit the power transmitted from the torque converter 3 to the driving wheel 20 via the engine disengaging clutch 4. The stator 3c has a torque amplifying function by including a one-way clutch. The torque converter 3 includes a lock-up clutch.

The engine disengaging clutch 4 as a power transmission clutch is disposed between the torque converter 3 and the shift transmission mechanism 5 on the power transmission path and is configured to connect/disconnect the power transmission between the torque converter 3 and the shift transmission mechanism 5. The engine disengaging clutch 4 is, for example, a frictional engagement type clutch device. The engine disengaging clutch 4 being in an engaged state connects the power transmission between the torque converter 3 and the shift transmission mechanism 5 to connect the engine 2 to the power transmission path. On the other hand, the engine disengaging clutch 4 being in a released state cuts off the power transmission between the torque converter 3 and the shift transmission mechanism 5 to separate the engine 2 from the power transmission path.

The shift transmission mechanism 5 has a function to change speed of the power that is output from the engine 2 via the torque converter 3. The shift transmission mechanism 5 is disposed between the torque converter 3 and the deceleration differential mechanism 6 on the power transmission path. In this embodiment, the shift transmission mechanism 5 specifically is a belt type continuously variable transmission (CVT). The shift transmission mechanism 5 includes a primary pulley 14 on a side of the engine 2, a secondary pulley 15 on a side of the driving wheel 20, and a metal belt 16 that is wound around by the primary pulley 14 and the secondary pulley 15 to perform the power transmission. The shift transmission mechanism 5 appropriately controls to engage or release a clutch C1 or a brake 1 in response to a control command from the ECU 10 and varies a winding diameter of the metal belt 16 by varying V groove widths of the primary pulley 14 and the secondary pulley 15 to change a transmission gear ratio (transmission gear stage). According to a selected transmission gear ratio, the power input to the input shaft 12 is shifted and output toward a side of the driving wheel 20.

Here, operations of the engine disengaging clutch 4, the lock-up clutch of the torque converter 3, and the shift transmission mechanism 5 (the pulleys 14 and 15, the clutch C1, and the brake B1) as described above are controlled by a hydraulic pressure of the hydraulic oil supplied by a hydraulic control unit (not illustrated). The hydraulic control unit is configured to control to switch engaging (or fastening) and releasing and a degree of engaging (or fastening) by adjusting the hydraulic pressure to supply to each of the units in response to the control command from the ECU 10.

The deceleration differential mechanism 6 is disposed between the shift transmission mechanism 5 and the driving wheel 20 on the power transmission path. The deceleration differential mechanism 6 includes a deceleration mechanism 6a and a differential mechanism 6b, which are constituted by combination of gears. A rotation input from the shift transmission mechanism 5 is decelerated by the deceleration differential mechanism 6 and further distributed to the driving wheels 20 on right and left.

The EOP 18 is a hydraulic pressure pump driven by a power source operated by an electricity of a motor or the like. The EOP 18 is a hydraulic pressure supply source that supplies a hydraulic pressure of hydraulic oil to the engine disengaging clutch 4, the lock-up clutch of the torque converter 3, and the shift transmission mechanism 5 (the pulleys 14 and 15, the clutch C1, and the brake B1).

The variable-displacement negative pressure pump 9 is driven by selectively using at least a torque from the engine 2 that is transmitted by the driving mechanism 7 and a torque from the driving wheel 20. The variable-displacement negative pressure pump 9 communicates with a negative pressure chamber 19a of the brake booster 19 as a brake booster. The variable-displacement negative pressure pump 9 is configured to vary the pressure inside the negative pressure chamber 19a to be a pressure less than an atmospheric pressure (hereinafter, a negative pressure) by suctioning air inside the negative pressure chamber 19a of the brake booster 19. The negative pressure chamber 19a communicates with a suction passage (an intake manifold: not illustrated) of the engine 2. This maintains the pressure inside the negative pressure chamber 19a to be the negative pressure by an intake negative pressure of the engine 2 when the engine 2 is in a state of self-sustained operation. The brake booster 19 with the negative pressure inside the negative pressure chamber 19a can amplify a brake pressure of a brake (not illustrated) in the vehicle Ve. In this description, the magnitude of the negative pressure is determined corresponding to a pressure and is a pressure representing a difference between an absolute pressure of a gas with a negative pressure and an atmospheric pressure of a gas, in an absolute value. In view of this, the larger the negative pressure of the gas, the smaller the absolute pressure of the gas. The detail of the variable-displacement negative pressure pump 9 will be described later.

The driving mechanism 7 is a device for transmitting the power to the MG 8 and the variable-displacement negative pressure pump 9. The driving mechanism 7 is constituted of a first power transmitter 36 (a first power transmission path) and a second power transmitter 37 (a second power transmission path). The driving mechanism 7 includes a transmission shaft 31, a one-way clutch 32, a pulley 33a and an auxiliary machine disengaging clutch 33b, a first sprocket 34, a second sprocket 35, the first power transmitter 36, and the second power transmitter 37.

The one-way clutch 32 is disposed in one end of the transmission shaft 31. The one-way clutch 32 includes an inner race 32a and an outer race 32b. When the number of rotations of the inner race 32a is less than the number of rotations of the outer race 32b, the inner race 32a and the outer race 32b integrally rotates and when the number of rotations of the inner race 32a is equal to or more than the number of rotations of the outer race 32b, the inner race 32a and the outer race 32b separately rotates. The inner race 32a of the one-way clutch 32 is fixedly secured in integrally rotatable manner with the transmission shaft 31.

The auxiliary machine disengaging clutch 33b is disposed in the other end of the transmission shaft 31. The auxiliary machine disengaging clutch 33b transmits and cuts off the power between the MG 8 and the variable-displacement negative pressure pump 9, which are the auxiliary machines, and the input shaft 12 of the shift transmission mechanism 5 on the transmission shaft 31. With this, the MG 8 is configured to be able to transmit the power to the input shaft 12. When the auxiliary machine disengaging clutch 33b is in the engaged state, the power is transmitted between the MG 8 and the variable-displacement negative pressure pump 9, which are the auxiliary machines, and the input shaft 12 of the shift transmission mechanism 5. When the auxiliary machine disengaging clutch 33b is in the released state, the power transmission is cut off between the MG 8 and the variable-displacement negative pressure pump 9, which are the auxiliary machines, and the input shaft 12 of the shift transmission mechanism 5. With this, the variable-displacement negative pressure pump 9 is configured to be selectively drivable by the torque from the driving wheel 20. While the illustrations are omitted in FIG. 1, a mechanical oil pump (MOP), a pump for power steering, a compressor for an air conditioner, and the like are disposed as the auxiliary machines.

The first sprocket 34 is fixedly secured in integrally rotatable manner with the crankshaft 11 of the engine 2. That is, the first sprocket 34 is disposed between the engine 2 and the engine disengaging clutch 4 on the first power transmission path. The second sprocket 35 is fixedly secured in integrally rotatable manner with the input shaft 12 of the shift transmission mechanism 5. That is, the second sprocket 35 is disposed between the torque converter 3 and the shift transmission mechanism 5 on the second power transmission path.

The first power transmitter 36 transmits the power between the outer race 32b of the one-way clutch 32 and the first sprocket 34. While the first power transmitter 36 is preferably applied with a chain that is wound around an outer periphery of the outer race 32b of the one-way clutch 32 and an outer periphery of the first sprocket 34, this should not be construed in a limiting sense and another component, such as a group of gears, may be applied. With this, the first power transmitter 36 is configured to be able to transmit the power from the engine 2 on the first power transmission path to the MG 8 and the variable-displacement negative pressure pump 9 via the one-way clutch 32. The second power transmitter 37 transmits the power between the auxiliary machine disengaging clutch 33b and the second sprocket 35. While the second power transmitter 37 is preferably applied with a chain that is wound around an outer periphery of the pulley 33a coupled to the auxiliary machine disengaging clutch 33b and an outer periphery of the second sprocket 35, this should not be construed in a limiting sense and another component, such as a group of gears, may be applied. The second power transmitter 37 transmits the power from the driving wheel 20 on the second power transmission path to the MG 8 and the variable-displacement negative pressure pump 9 via the pulley 33a and the auxiliary machine disengaging clutch 33b in the engaged state. This can drive the MG 8, the variable-displacement negative pressure pump 9, and the like from the driving wheel 20 side.

In the driving mechanism 7, the first sprocket 34, the first power transmitter 36, and the one-way clutch 32 form a first driving path, which couples the crankshaft 11 of the engine 2 to the transmission shaft 31 of the MG 8. In the first driving path, due to a function of the one-way clutch 32, the power transmission from the crankshaft 11 of the engine 2 to the transmission shaft 31 of the MG 8 is permitted, and the power transmission from the transmission shaft 31 to the crankshaft 11 is blocked (the one-way clutch 32 runs idle).

In the driving mechanism 7, the second sprocket 35, the second power transmitter 37, the pulley 33a, and the auxiliary machine disengaging clutch 33b form a second driving path, which couples the input shaft 12 of the shift transmission mechanism 5 to the transmission shaft 31 of the MG 8. In the second driving path, due to a function of the auxiliary machine disengaging clutch 33b, the power of the input shaft 12 of the shift transmission mechanism 5 and the transmission shaft 31 of the MG 8 is transmitted or cut off.

The ECU 10 as a controller physically is an electronic circuit that mainly is a well-known microcomputer including a Central Processing Unit (CPU), a Random Access Memory (RAM), a Read Only Memory (ROM), an interface, and the like. Each of the functions of the ECU 10 as described above is achieved by loading an application program held in the ROM to the RAM and executing the application program in the CPU to operate various kinds of devices in the vehicle Ve under control of the CPU and by performing reading data in the RAM or the ROM and writing into the RAM.

The ECU 10 controls each units of the vehicle Ve, such as the engine 2, the torque converter 3, the engine disengaging clutch 4, the shift transmission mechanism 5, and the MG 8, based on an operating state of the engine 2 by a driver and a driving state of this engine 2 to comprehensively control the travelling of the vehicle Ve. The ECU 10 controls each units of the vehicle Ve to execute a free-running control.

In the free-running control, the engine 2 is automatically stopped while the vehicle Ve is travelling to cause the vehicle Ve to travel by coasting in order to improve fuel efficiency. In the free-running control, the engine disengaging clutch 4 is released when the engine 2 is stopped in order to restrain a shock caused by the stop of the engine 2 from being transmitted. In other words, the free-running is to cut off the power transmission between the engine 2 and the shift transmission mechanism 5 by releasing the engine disengaging clutch 4 while the vehicle Ve is travelling and to cause the vehicle Ve to freewheel in a state where the engine 2 is stopped. In this free-running control, stopping the fuel consumption in the engine 2 ensures improving the fuel efficiency.

The ECU 10 performs releasing the engine disengaging clutch 4 and automatically stopping the engine 2 to execute the free-running control when an engine automatic stop condition (for example, a state where accelerator is off and brake is off) is satisfied while the vehicle Ve is travelling. When the ECU 10 automatically stops the engine 2, a fuel supply and an ignition to the engine 2 are stopped. The ECU 10 engages the engine disengaging clutch 4 and starts the engine 2 to recover from the free-running when an engine automatic start condition (for example, the driver depressing an accelerator pedal) is satisfied while the free-running control is in execution.

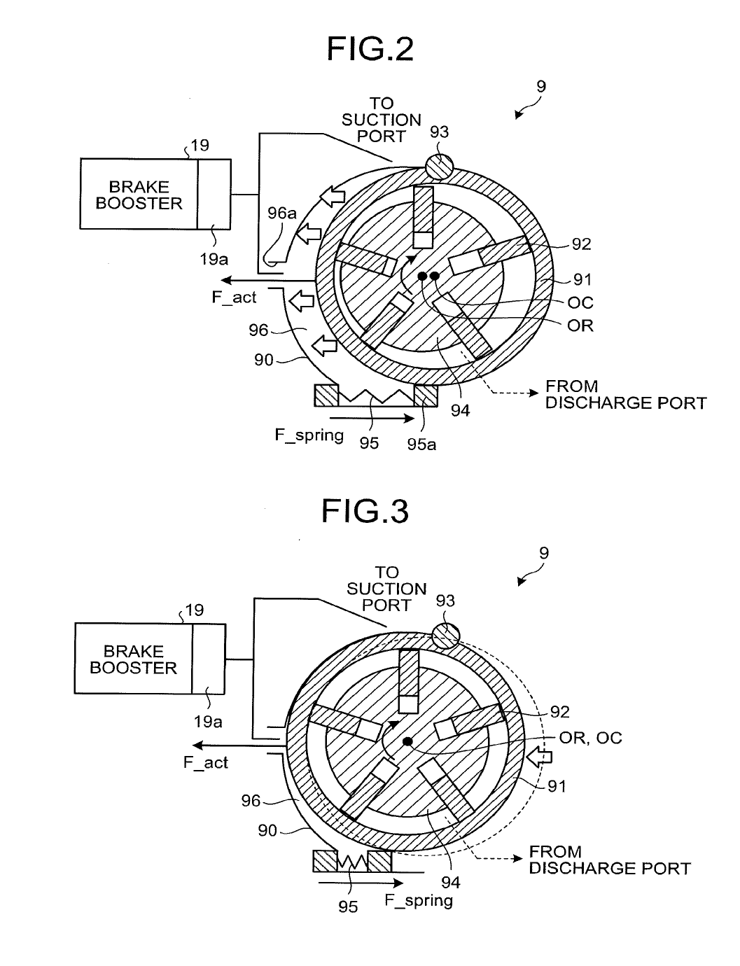

Next, the following describes the detail of the variable-displacement negative pressure pump 9 used in the vehicle driving device according to the embodiment of the disclosure. FIGS. 2 and 3 are schematic diagrams illustrating a structure of the variable-displacement negative pressure pump 9 in the maximum discharging state and the minimum discharging state, respectively.

As illustrated in FIGS. 2 and 3, the variable-displacement negative pressure pump 9 is a variable-displacement type vane pump. The variable-displacement negative pressure pump 9 is constituted so as to include a cam ring 91, vanes 92, a swinging pin 93, a rotor 94, and a coil spring 95 inside a pump body 90. A space between the pump body 90 and the cam ring 91 constitutes a control chamber 96. The coil spring 95 has one end secured to the pump body 90 and the other end coupled to a movable pressing portion 95a. The pressing portion 95a is disposed displaced by one half rotation from the swinging pin 93 in a circumferential direction on an outer periphery of the cam ring 91 and in an opposite side of the swinging pin 93 with respect to the center. In other words, the swinging pin 93 and the pressing portion 95a are disposed at positions approximately symmetrical about the center.

The cam ring 91 is housed inside the pump body 90 forming an approximate ring shape. The cam ring 91 is swingably held with respect to the pump body 90 via the swinging pin 93 interposed at a part of the outer periphery. That is, the swinging pin 93 is sandwiched between the part of the outer peripheral surface of the cam ring 91 and a part of an inner peripheral surface of the pump body 90.

The control chamber 96 is partitioned by the swinging pin 93 and the pressing portion 95a between the inner surface of the pump body 90 and the outer surface of the cam ring 91. In the pump body 90, a control port 96a, which communicates with the control chamber 96, is disposed to communicate with the negative pressure chamber 19a of the brake booster 19. With this, an air pressure inside the control chamber 96 is configured to be controllable corresponding to the magnitude of the negative pressure inside the negative pressure chamber 19a of the brake booster 19. The magnitude of the negative pressure inside the control chamber 96 varies and this negative pressure becomes a thrust to cause the cam ring 91 to swing. Causing the magnitude of the negative pressure large increases the thrust to swing the cam ring 91 to reduce the capacity of the variable-displacement negative pressure pump 9. The coil spring 95 as an elastic body in contact with the pressing portion 95a causes an elastic force acting with respect to the cam ring 91 to a direction against a direction to which the cam ring 91 relatively moves with respect to the rotor 94 by the negative pressure inside the control chamber 96 (void arrows in FIG. 2), that is, a direction against the cam ring thrust. The cam ring 91 has an inner periphery side on which the rotor 94 is disposed. The rotor 94 forms a ring shape with approximate Y-shaped cross-sectional surfaces connected in series. The approximate Y-shaped cross-sectional surfaces are installed in a shaft (not illustrated). On a circumference of the rotor 94, slit grooves are radially formed. The respective slit grooves house ends on inner peripheral sides, which are base ends, of the vanes 92 to cause the respective vanes 92 to move freely in a radiation direction. The respective vanes 92 have outer peripheral side ends, which are distal ends, slidably in contact with the inner peripheral surface of the cam ring 91.

In the pump body 90 of the variable-displacement negative pressure pump 9, a suction port that suctions air and a discharge port that discharges the air (both not illustrated) are formed. That is, the cam ring 91 is decentered with respect to the rotor 94. In between pairs of the vanes 92 adjacent to one another, air chambers are airtightly partitioned and formed by the vanes 92 and the inner peripheral surface of the cam ring 91 and the outer peripheral surface of the rotor 94 and the inner peripheral surface of the pump body 90. A volume of the air chamber partitioned and formed increases and decreases in accordance with the rotation of the rotor 94 and the vanes 92. The upper half of a region in a rotation region of the vanes 92 is a suction region that gradually increases the volume of the air chambers when the rotor 94 rotates clockwise in the drawing. The suction port (not illustrated) is formed so as to open to the suction region. The lower half of the rotation region of the vanes 92 is a discharge region that gradually reduces the volume of the air chambers. The discharge port (not illustrated) is formed so as to open to the discharge region.

The control port 96a and the suction port (not illustrated) of the variable-displacement negative pressure pump 9 communicate with the negative pressure chamber 19a of the brake booster 19. Therefore, as illustrated in FIG. 2, the operation of the variable-displacement negative pressure pump 9 causes the pressure inside the negative pressure chamber 19a of the brake booster 19 to be the negative pressure. Together with this, as illustrated in FIG. 3, swinging the cam ring 91 according to the magnitude of the negative pressure inside the control chamber 96, which communicates with the negative pressure chamber 19a, can vary a decentering amount of the cam ring 91 with respect to the rotor 94 to vary the capacity.

That is, when the decentering amount between a rotational center OR of the rotor 94 and a swinging center OC of the cam ring 91 is the maximum, the capacity is the maximum, as illustrated in FIG. 2. The state where the decentering amount between the rotational center OR and the swinging center OC is the maximum is achievable by controlling a cam ring thrust F_act to be less than an elastic force F_spring of the coil spring 95 (F_act<F_spring). On the other hand, when the decentering amount between the rotational center OR of the rotor 94 and the swinging center OC of the cam ring 91 is the minimum (such as zero), the capacity is the minimum in the variable-displacement negative pressure pump 9, as illustrated in FIG. 3. The state where the decentering amount between the rotational center OR and the swinging center OC is the minimum is achievable by controlling the cam ring thrust F_act to be equal to or more than the elastic force F_spring of the coil spring 95 (F_act≧F_spring). The detail of a coupling configuration of the variable-displacement negative pressure pump 9 and the brake booster 19 will be described later.

### FIRST EXAMPLE

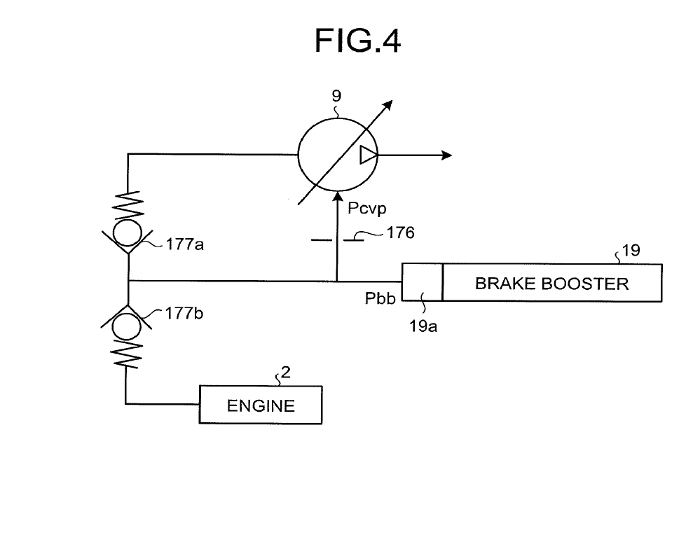

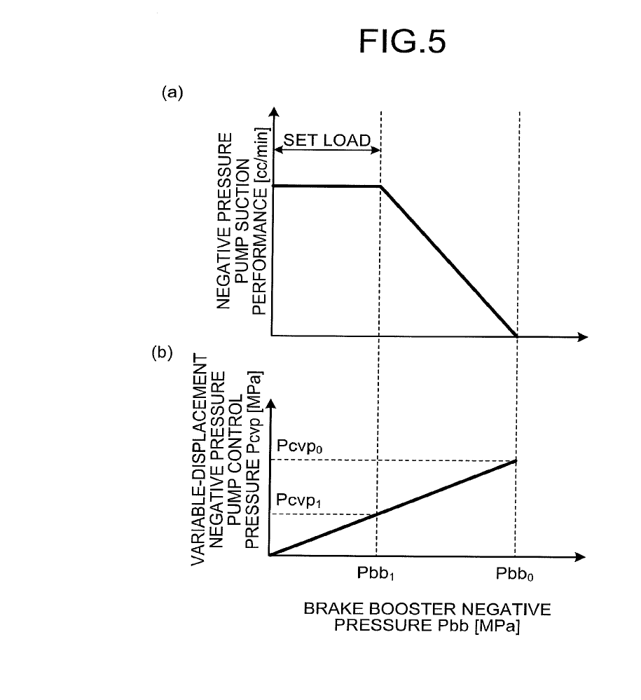

Next, the following describes an air pressure circuit using the variable-displacement negative pressure pump 9 according to the embodiment configured as described above. FIG. 4 is a circuit diagram illustrating the first air pressure circuit according to the first example. FIG. 5 is a graph illustrating a suction performance ((a) of FIG. 5) of the negative pressure pump and a control pressure ((b) of FIG. 5) of the variable-displacement negative pressure pump corresponding to the negative pressure of the brake booster in the first air pressure circuit.

As illustrated in FIG. 4, the first air pressure circuit is configured to include the engine 2, the variable-displacement negative pressure pump 9, the brake booster 19, an orifice 176, and non-return valves 177a and 177b. The negative pressure chamber 19a of the brake booster 19 is coupled to the control chamber 96 of the variable-displacement negative pressure pump 9 via the orifice 176 and communicates with the suction port of the variable-displacement negative pressure pump 9 via the non-return valve 177a. With the non-return valve 177a, while airflow from the negative pressure chamber 19a to the variable-displacement negative pressure pump 9 is permitted, airflow from the variable-displacement negative pressure pump 9 to the negative pressure chamber 19a is cut off. This can cut off the communication between the variable-displacement negative pressure pump 9 and the negative pressure chamber 19a until the negative pressure inside the negative pressure chamber 19a reaches a predetermined negative pressure, thereby ensuring shortening the time that the negative pressure inside the negative pressure chamber 19a takes to reach the predetermined negative pressure.

A negative pressure Pbb inside the negative pressure chamber 19a is stepped down by the orifice 176 to be a control pressure of the negative pressure Pcvp. In the following description, the control pressure Pcvp is the negative pressure. The pressure inside the control chamber 96 of the variable-displacement negative pressure pump 9 becomes the control pressure Pcvp and the capacity of the variable-displacement negative pressure pump 9 is controlled according to the magnitude of the control pressure Pcvp. On the other hand, the negative pressure chamber 19a of the brake booster 19 is further coupled to the intake manifold (not illustrated) the engine 2 via the non-return valve 177b. With the non-return valve 177b, while airflow from the negative pressure chamber 19a to the engine 2 is permitted, airflow from the engine 2 to the negative pressure chamber 19a is cut off. This can cause the pressure inside the negative pressure chamber 19a to be in the negative pressure state by a suction negative pressure of the engine 2 while the engine 2 is operating.

In the first air pressure circuit, as illustrated in (b) of FIG. 5, the pressure of the control pressure Pcvp inside the control chamber 96 of the variable-displacement negative pressure pump 9 has a proportional relation corresponding to the magnitude of the negative pressure Pbb inside the negative pressure chamber 19a of the brake booster 19. An inclination of a straight line (Pcvp/Pbb) in (b) of FIG. 5 depends on a specification of the orifice 176.

As described above, in the variable-displacement negative pressure pump 9, the control pressure Pcvp inside the control chamber 96 becomes the cam ring thrust, which causes the cam ring 91 to swing. An elastic force acts on the cam ring 91 in a direction against the cam ring thrust by the coil spring 95 contacting the pressing portion 95a. Therefore, the cam ring 91 does not swing and the suction performance of the variable-displacement negative pressure pump 9 does not vary (set load) until the pressure inside the negative pressure chamber 19a of the brake booster 19 reaches a predetermined negative pressure Pbb₁ as illustrated in (a) of FIG. 5, and the control pressure inside the control chamber 96 reaches a predetermined control pressure Pcvp₁. When the pressure inside the negative pressure chamber 19a is equal to or more than the predetermined negative pressure Pbb₁, the control pressure Pcvp is also equal to or more than the predetermined control pressure Pcvp₁, and the coil spring 95 can be contracted to a position balanced with the elastic force by the cam ring thrust. This causes the cam ring 91 to swing from the state illustrated in FIG. 2 to the state illustrated in FIG. 3 in response to the magnitude of the control pressure Pcvp. As illustrated in (a) of FIG. 5, when the pressure inside the negative pressure chamber 19a is equal to or more than a predetermined negative pressure Pbb₀ and the control pressure inside the control chamber 96 is equal to or more than a predetermined control pressure Pcvp₀, the suction performance of the variable-displacement negative pressure pump 9 becomes zero to restrain the generation of the negative pressure by the variable-displacement negative pressure pump 9.

According to the first example, the negative pressure Pbb inside the negative pressure chamber 19a of the brake booster 19 can control the capacity of the variable-displacement negative pressure pump 9, thereby ensuring a simple configuration for configuring the first air pressure circuit. The orifice 176 steps down the negative pressure Pbb inside the negative pressure chamber 19a of the brake booster 19 to cause the negative pressure Pbb to become the control pressure Pcvp. This can downsize the coil spring 95 of the variable-displacement negative pressure pump 9, thereby ensuring an improved assembility of the variable-displacement negative pressure pump 9. Decreasing the negative pressure generated corresponding to the suction performance of the variable-displacement negative pressure pump 9 when the negative pressure generated inside the negative pressure chamber 19a of the brake booster 19 is equal to or more than the predetermined negative pressure Pbb₁ can restrain the generation of the negative pressure by the variable-displacement negative pressure pump 9 during normal travelling of the vehicle Ve, thereby ensuring a reduced energy loss by reducing an energy of the engine 2 consumed by the operation of the variable-displacement negative pressure pump 9 to improve the fuel efficiency of the vehicle Ve.

### SECOND EXAMPLE

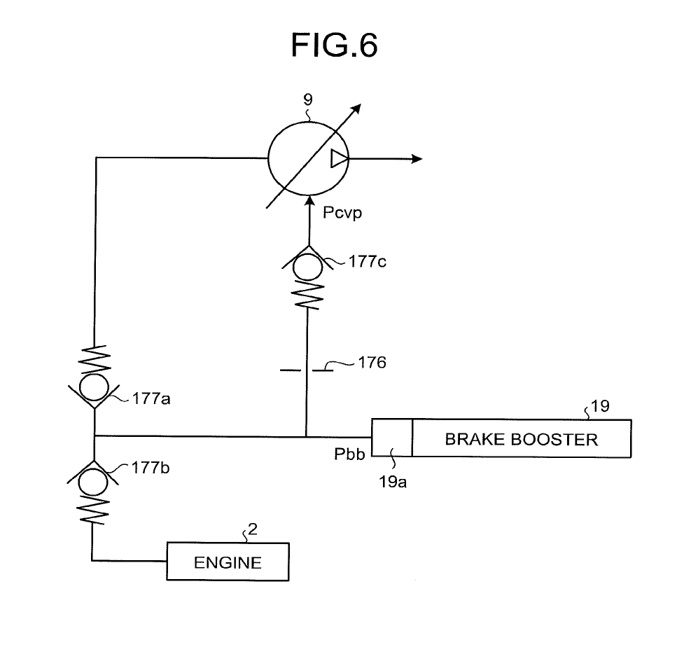

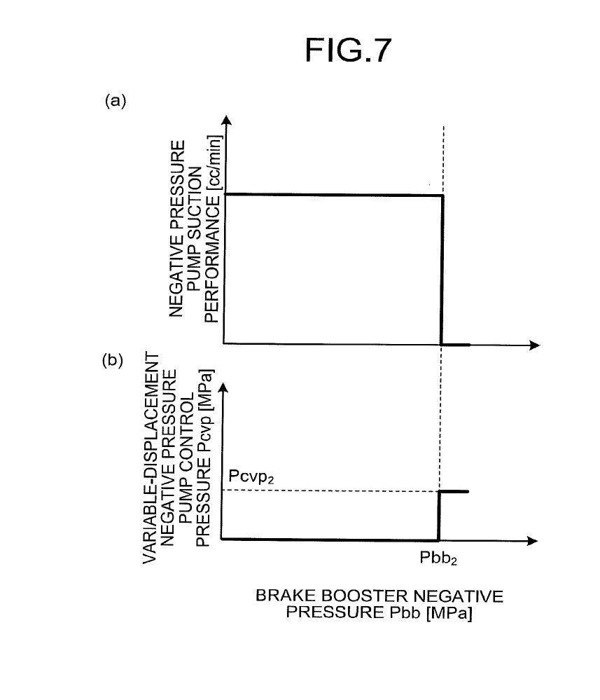

Next, the following describes a second air pressure circuit using the variable-displacement negative pressure pump 9. FIG. 6 is a circuit diagram illustrating the second air pressure circuit according to the second example. FIG. 7 is a graph illustrating the suction performance ((a) of FIG. 7) of the negative pressure pump and the control pressure ((b) of FIG. 7) of the variable-displacement negative pressure pump corresponding to the negative pressure of the brake booster in the second air pressure circuit.

As illustrated in FIG. 6, the second air pressure circuit is different from the first example. The second air pressure circuit includes a check valve 177c between the orifice 176 and the variable-displacement negative pressure pump 9. With the check valve 177c as a non-return valve, while airflow from the control chamber 96 of the variable-displacement negative pressure pump 9 to the negative pressure chamber 19a of the brake booster 19 is permitted, airflow from the negative pressure chamber 19a to the control chamber 96 is cut off. This maintains the control pressure Pcvp inside the control chamber 96 to be zero, that is, the atmospheric pressure, until the negative pressure Pbb inside the negative pressure chamber 19a reaches the predetermined negative pressure. Other configurations are similar to the first example.

In the second air pressure circuit, as illustrated in (b) of FIG. 7, the control pressure Pcvp inside the control chamber 96 of the variable-displacement negative pressure pump 9 remains zero when the magnitude of the negative pressure Pbb inside the negative pressure chamber 19a of the brake booster 19 is less than a predetermined negative pressure Pbb₂. This operates the variable-displacement negative pressure pump 9 at the maximum suction performance. On the other hand, when the negative pressure Pbb inside the negative pressure chamber 19a is equal to or more than the predetermined negative pressure Pbb₂, the check valve 177c is released to cause the negative pressure inside the control chamber 96 to reach the predetermined control pressure Pcvp₂. As illustrated in (a) of FIG. 7, when the pressure inside the negative pressure chamber 19a is equal to or more than the negative pressure Pbb₂ and the control pressure Pcvp inside the control chamber 96 reaches the predetermined control pressure Pcvp₂, the suction performance of the variable-displacement negative pressure pump 9 becomes zero (the minimum suction performance) to restrain the generation of the negative pressure by the variable-displacement negative pressure pump 9. The predetermined negative pressure Pbb₂ can be set according to a design and a selection of the check valve 177c. The predetermined control pressure Pcvp₂ can be set according to a design and a selection of the set predetermined negative pressure Pbb₂ and the orifice 176. Furthermore, appropriately setting the magnitude of the elastic force of the coil spring 95 allows a design of the suction performance of the variable-displacement negative pressure pump 9 to be zero at the predetermined control pressure Pcvp₂.

According to the second example, the communication between the control chamber 96 and the negative pressure chamber 19a is cut off until the negative pressure Pbb inside the negative pressure chamber 19a reaches the predetermined negative pressure Pbb₂. Therefore, the air inside the control chamber 96 is not suctioned until the pressure inside the negative pressure chamber 19a reaches the predetermined negative pressure Pbb₂. This can shorten the time that the negative pressure Pbb inside the negative pressure chamber 19a takes to reach the predetermined negative pressure Pbb₂ compared with the first air pressure circuit. Since it is only necessary to cause the suction performance of the variable-displacement negative pressure pump 9 to be zero at the predetermined control pressure Pcvp₂, the elastic force of the coil spring 95 can be further decreased compared with the first example, thereby ensuring further downsizing the coil spring 95 and further improving the assembility of the variable-displacement negative pressure pump 9.

### THIRD EXAMPLE

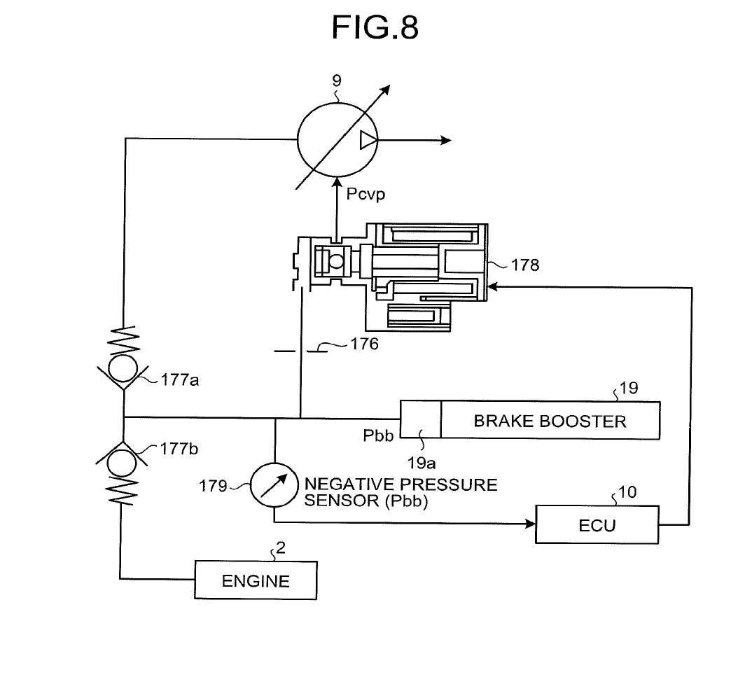

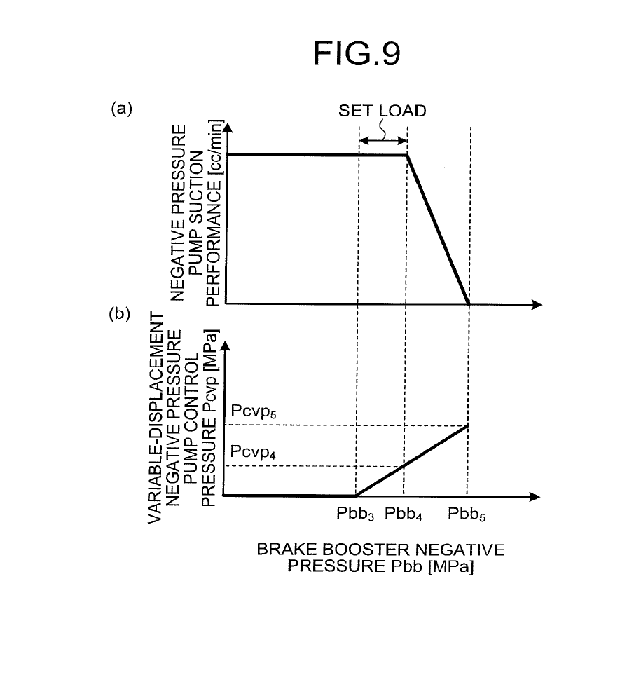

Next, the following describes a third air pressure circuit using the variable-displacement negative pressure pump 9. FIG. 8 is a circuit diagram illustrating the third air pressure circuit according to the third example. FIG. 9 is a graph illustrating the suction performance ((a) of FIG. 9) of the negative pressure pump and the control pressure ((b) of FIG. 9) of the variable-displacement negative pressure pump corresponding to the negative pressure of the brake booster in the third air pressure circuit.

As illustrated in FIG. 8, the third air pressure circuit is different from the first example. The third air pressure circuit includes a solenoid 178 between the orifice 176 and the variable-displacement negative pressure pump 9. For the solenoid 178, a duty solenoid or a linear solenoid can be employed. Between the negative pressure chamber 19a of the brake booster 19 and the non-return valves 177a and 177b, a negative pressure sensor 179 to measure the negative pressure of the negative pressure chamber 19a is disposed. The solenoid 178 is controlled by the ECU 10. The ECU 10 controls the solenoid 178 based on data of the measurement value of the negative pressure Pbb supplied from the negative pressure sensor 179. Other configurations are similar to the first example.

In the third air pressure circuit, as illustrated in (b) of FIG. 9, when the magnitude of the negative pressure Pbb inside the negative pressure chamber 19a of the brake booster 19 is less than a predetermined negative pressure Pbb₃, the control pressure Pcvp inside the control chamber 96 of the variable-displacement negative pressure pump 9 is controlled to be zero by the solenoid 178. When the negative pressure Pbb inside the negative pressure chamber 19a is equal to or more than the predetermined negative pressure Pbb₃, the solenoid 178 is released and the control pressure Pcvp inside the control chamber 96 is increased proportionating to an increase of the negative pressure Pbb inside the negative pressure chamber 19a. As described above, while the control pressure Pcvp inside the control chamber 96 becomes the cam ring thrust that causes the cam ring 91 to swing, the elastic force against the cam ring thrust acts on the cam ring 91 by the coil spring 95. Therefore, as illustrated in (a) of FIG. 9, the cam ring 91 does not swing and the suction performance of the variable-displacement negative pressure pump 9 does not vary (set load) until the pressure inside the negative pressure chamber 19a reaches a predetermined negative pressure Pbb₄. When the pressure inside the negative pressure chamber 19a is equal to or more than the predetermined negative pressure Pbb₄, the control pressure Pcvp is also equal to or more than a predetermined control pressure Pcvp₄, and the coil spring 95 is contracted to a position balanced with the elastic force by the cam ring thrust. This causes the cam ring 91 to swing from the state illustrated in FIG. 2 toward the state illustrated in FIG. 3 in response to the magnitude of the negative pressure of the control pressure Pcvp. As illustrated in (a) of FIG. 9, when the negative pressure Pbb inside the negative pressure chamber 19a is equal to or more than a predetermined negative pressure Pbb₅, the cam ring 91 swings to the maximum to cause the decentering amount between the rotor 94 and the cam ring 91 to be zero to cause the suction performance of the variable-displacement negative pressure pump 9 to be zero, thereby restraining the generation of the negative pressure by the variable-displacement negative pressure pump 9.

According to the third example, since the communication between the control chamber 96 and the negative pressure chamber 19a are cut off until the negative pressure Pbb inside the negative pressure chamber 19a reaches the predetermined negative pressure Pbb₃, the time that the negative pressure Pbb inside the negative pressure chamber 19a takes to reach the predetermined negative pressure Pbb₃ can be shortened compared with the first air pressure circuit. Since it is only necessary to cause the suction performance of the variable-displacement negative pressure pump 9 to be zero at the predetermined control pressure Pcvp₅, the elastic force of the coil spring 95 can be decreased compared with the first example, thereby ensuring downsizing the coil spring 95 and further improving the assembility of the variable-displacement negative pressure pump 9. Furthermore, in the case of the second air pressure circuit, the operation of the variable-displacement negative pressure pump 9 varies from the maximum suction performance to the minimum suction performance all at once when the negative pressure Pbb of the negative pressure chamber 19a reaches the predetermined negative pressure Pbb₂, therefore, there is a possibility to generate an operational shock of the variable-displacement negative pressure pump 9. In contrast to this, in the third air pressure circuit, since the variable-displacement negative pressure pump 9 varies from the maximum suction performance to the minimum suction performance slowly in phases, the generation of the operational shock can be restrained.

Modification of Variable-Displacement Negative Pressure Pump

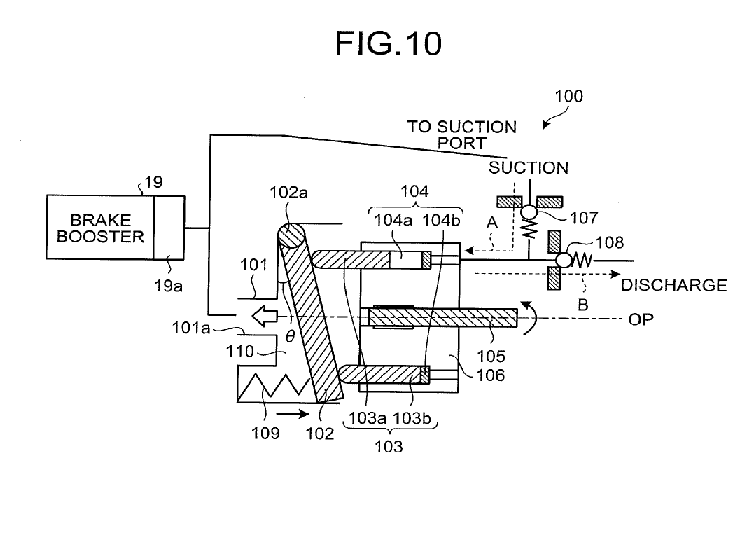

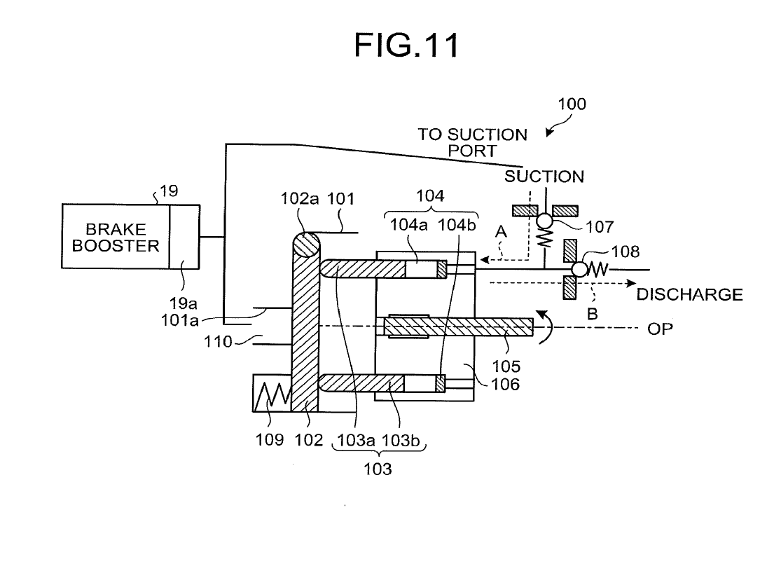

Next, the following describes a modification of the variable-displacement negative pressure pump used in the vehicle driving device according to the above-described embodiment. FIGS. 10 and 11 are schematic diagrams illustrating a structure of the variable-displacement negative pressure pump in the maximum discharging state and the minimum discharging state, respectively.

As illustrated in FIGS. 10 and 11, a variable-displacement negative pressure pump 100 according to the modification is a variable-displacement type axial piston pump. The variable-displacement negative pressure pump 100 is configured to include a variable swash plate 102, pistons 103, a cylinder block 106, a shaft 105, check balls 107 and 108, and a coil spring 109 inside a casing 101.

The variable swash plate 102 configured to be a plate shape has one end on a plate-shaped side surface in contact with the casing 101. A swinging pin 102a is disposed on the one end. That is, the one end of the variable swash plate 102 and an inner periphery of the casing 101 sandwich the swinging pin 102a, and the variable swash plate 102 is configured to be swingable using the swinging pin 102a as an axis. The cylinder block 106 is configured to be rotatable with the shaft 105 via a spline (not illustrated) using a rotation axis OP as a center. The shaft 105 is coupled to an external power source, such as the MG 8 and the engine 2, and is configured to rotate by the power of the power source. The cylinder block 106 includes a plurality of cylinder bores 104 formed parallel to an axis line of the shaft 105. The pistons 103 (103a and 103b) are disposed within the respective cylinder bores 104 (104a and 104b) in a reciprocatable manner. Distal ends of the pistons 103 come in contact with a sliding surface as a main surface of the variable swash plate 102.

A space formed by a back surface of the variable swash plate 102, which is an opposite side of the sliding surface, and an inner surface of the casing 101 constitutes a control chamber 110. The control chamber 110 communicates with the negative pressure chamber 19a of the brake booster 19 through a control port 101a of the casing 101. By the negative pressure chamber 19a causing the pressure inside the control chamber 110 to be the negative pressure, a swing thrust that causes the variable swash plate 102 to swing using the swinging pin 102a as the center acts on the variable swash plate 102. The coil spring 109 as an elastic body has one end secured to the casing 101 and the other end coupled to another end of the variable swash plate 102 with one end on which the swinging pin 102a is disposed. This causes the coil spring 109 to cause the elastic force to act on the variable swash plate 102 in a direction against a direction to which the variable swash plate 102 swings (a void arrow in FIG. 10) by the negative pressure inside the control chamber 110, that is, in a direction against the swing thrust.

These check balls 107 are disposed on a side of a suction port of the variable-displacement negative pressure pump 100. The check ball 107 is disposed so as to permit an inflow of air from outside (a dashed arrow A in the drawing) and restrain an outflow of air from inside. The check ball 108 is disposed on a side of a discharge port of the variable-displacement negative pressure pump 100. The check ball 108 is disposed so as to permit an outflow of air from the inside (a dashed arrow B in the drawing) and restrain an inflow of air from the outside.

The following describes operations of the variable-displacement negative pressure pump 100 configured as described above. In the following description, the piston 103 is used when generally referring to a piston, and the pistons 103a and 103b are used when describing a piston whose position should be identified.

First, the shaft 105 rotates by receiving a driving force from the external power source, and the cylinder block 106 also rotates. When the cylinder block 106 rotates, the piston 103 in the cylinder bore 104 rotates in a state where the distal end is pressed against the variable swash plate 102. This causes the piston 103 to reciprocally move in the cylinder bore 104 by being guided by the sliding surface of the variable swash plate 102.

The piston 103b positioned in the lowermost in FIG. 10 positions in the rearmost in the cylinder bore 104b. When the cylinder block 106 rotates from the rearmost position, the distal end of the piston 103b is guided along the sliding surface of the variable swash plate 102 to move to a front of the cylinder bore 104b. As a result, the piston 103b moves to the frontmost position in the cylinder bore 104a where the piston 103a positions. The piston 103 moving from the rearmost position to the frontmost position releases the check ball 107 and air is suctioned from the suction port, as the dashed arrow A illustrates. Furthermore, when the shaft 105 rotates, the piston 103a that positions in the frontmost moves to the rearmost position where the piston 103b positions. The piston 103 moving from the frontmost position to the rearmost position releases the check ball 108 and air is discharged from the discharge port, as the dashed arrow B illustrates. The above-described cycle is performed for the plurality of pistons 103 disposed in the cylinder block 106 in order to continuously suction and discharge the air.

An angle θ of the variable swash plate 102 is an angle the sliding surface of the variable swash plate 102 provides with respect to a state of zero degrees. Zero degrees is when the sliding surface on which the distal end of the piston 103 slides is perpendicular to the rotation axis OP of the shaft 105. As illustrated in FIG. 11, when the angle θ of the variable swash plate 102 is zero degrees, the piston 103 does not make reciprocating motion, and the piston 103 does not move. Therefore, the variable-displacement negative pressure pump 100 is in the minimum discharge state where the discharge amount is the minimum (0) to have the minimum suction performance. This state is achievable when the magnitude of the negative pressure inside the control chamber 110 is equal to or more than the predetermined negative pressure and the swing thrust acts against the elastic force of the coil spring 109 until the angle θ of the variable swash plate 102 becomes zero degrees. Meanwhile, as illustrated in FIG. 10, as the angle θ of the variable swash plate 102 becomes large, the discharge amount of the variable-displacement negative pressure pump 100 increases. This state is a state where the swing thrust does not act against the elastic force of the coil spring 109 until the angle θ of the variable swash plate 102 becomes approximately zero degrees with the magnitude of the negative pressure inside the control chamber 110 being less than the predetermined negative pressure. When the angle θ of the variable swash plate 102 is the maximum angle, the discharge amount is the maximum to be in the maximum discharge state, therefore, the variable-displacement negative pressure pump 100 has the maximum suction performance.

Thus, the angle θ of the variable swash plate 102 varies according to the magnitude of the negative pressure inside the control chamber 110. Therefore, even the variable-displacement negative pressure pump 100 according to this modification can be used as a variable-displacement negative pressure pump in the above-described first to third air pressure circuits. Furthermore, even in the variable-displacement negative pressure pump 100 according to the modification, the suction performance can be varied according to the magnitude of the negative pressure inside the negative pressure chamber 19a of the brake booster 19 similarly to the above-described embodiment, thereby ensuring obtaining advantageous effects similar to the above-described embodiment.

With a vehicle driving device according to the disclosure, when a negative pressure generated in a negative pressure chamber of a brake booster is equal to or more than a predetermined negative pressure, a negative pressure in a negative pressure pump that is configured to vary the negative pressure generated is decreased to restrain the generation of the negative pressure by the negative pressure pump during a normal travelling of a vehicle, thereby ensuring a reduced energy loss of an engine consumed by driving the negative pressure pump to improve fuel efficiency of the vehicle.

In some embodiments, the vehicle driving device further includes a non-return valve configured to restrain an inflow of air to the negative pressure pump in a path between the brake booster and the negative pressure pump. With this configuration, a communication between a control chamber and a negative pressure chamber is configured to be cut off until a negative pressure inside the negative pressure chamber reaches a predetermined negative pressure, thereby ensuring shortening a time that the negative pressure inside the negative pressure chamber takes to reach the predetermined negative pressure.

In some embodiments, the vehicle driving device further includes a solenoid configured to control a magnitude of the negative pressure inside the control chamber in response to a magnitude of the negative pressure inside the negative pressure chamber in a path between the brake booster and the negative pressure pump. With this configuration, the suction performance of the negative pressure pump is configured to slowly vary in phases from the maximum suction performance to the minimum suction performance by controlling the solenoid, thereby ensuring restraining a generation of an operational shock caused when instantaneously varying from the maximum suction performance to the minimum suction performance.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A vehicle driving device comprising:
an engine;
a brake booster including a negative pressure chamber, the brake booster amplifying a brake pressure by a negative pressure determined corresponding to a pressure inside the negative pressure chamber;
a power transmission clutch disposed between the engine and a driving wheel; and
a negative pressure pump configured to drive by using at least one of a torque from the engine and a torque from the driving wheel, the negative pressure pump being configured to vary the negative pressure inside the negative pressure chamber, wherein
in the vehicle driving device included in a vehicle that performs freewheeling in a state where the power transmission clutch is released and the engine is stopped, the negative pressure pump includes a control chamber configured to reduce a capacity of the negative pressure pump as a magnitude of the negative pressure inside the negative pressure chamber increases.

2. The vehicle driving device according to claim 1, wherein
the negative pressure pump includes:
a cam ring configured to vary the capacity of the negative pressure pump by a relative movement of the cam ring; and
an elastic body configured to press the cam ring in a direction that increases the capacity of the negative pressure pump, and
the control chamber communicates with the negative pressure chamber and is configured to vary the capacity of the negative pressure pump by relatively moving the cam ring against an elastic force by the elastic body in response to the negative pressure inside the negative pressure chamber.

3. The vehicle driving device according to claim 1, wherein
the negative pressure pump includes:
a variable swash plate configured to vary the capacity of the negative pressure pump by swinging the variable swash plate; and
an elastic body configured to press the variable swash plate in a direction that increases the capacity of the negative pressure pump, and
the control chamber communicates with the negative pressure chamber and is configured to vary the capacity of the negative pressure pump by swinging the variable swash plate against an elastic force by the elastic body in response to the negative pressure inside the negative pressure chamber.

4. The vehicle driving device according to claim 1, further comprising
a non-return valve configured to restrain an inflow of air to the negative pressure pump in a path between the brake booster and the negative pressure pump.

5. The vehicle driving device according to claim 1, further comprising
a solenoid configured to control a magnitude of the negative pressure inside the control chamber in response to a magnitude of the negative pressure inside the negative pressure chamber in a path between the brake booster and the negative pressure pump.
